(19) United States
(12) Patent Application Publication
(10) Pub. No.: US 2010/0098248 A1
(43) Pub. Date: Apr. 22, 2010

(54) DEVICE AND METHOD OF GENERATING AND DISTRIBUTING ACCESS PERMISSION TO DIGITAL OBJECT

(75) Inventor: Lakshminarayanan Anantharaman, Singapore (SG)

Correspondence Address: FOLEY & LARDNER LLP, P.O. BOX 80278, SAN DIEGO, CA, 92138-0278, US

(73) Assignee: AGENCY FOR SCIENCE TECHNOLOGY AND RESEARCH, Centros (SG)

(21) Appl. No.: 12/447,883

(22) PCT Filed: Oct. 31, 2007
(86) PCT No.: PCT/SG07/00365

§ 371 Date: Jun. 24, 2009

Related U.S. Application Data
(60) Provisional application No. 60/863,739, filed on Oct. 31, 2006.

(51) Int. Cl. H04L 9/32; G06F 15/16; H04L 9/00

(52) U.S. Cl. 380/44; 709/229; 713/176

(57) ABSTRACT

A system is provided, which includes at least one digital object owner client computing device, a trusted server computing device and at least one digital object consumer client computing device. Each of said at least one digital object owner client computing device is configured to transmit a created or amended access permission message to the trusted server computing device. The trusted server computing device is configured to generate, from the created or amended access permission message, at least one personalized access permission message, each of which is uniquely addressed to one of the at least one digital object consumer client computing device. The at least one digital object consumer client computing device is configured to enforce a download, from the trusted server computing device, of the at least one personalized access permission message uniquely addressed to the at least one digital object consumer client computing device.

### CROSS-REFERENCE TO RELATED APPLICATION

This application claims the benefit of priority of U.S. provisional application 60/863,739 filed on 31 Oct. 2006, the entire content of which is incorporated here by reference for all purposes.

### FIELD OF THE INVENTION

The present invention relates generally to sharing of digital objects in communication networks, in particular to the generating and distributing of access permission to digital objects.

### BACKGROUND

Nowadays, it is common for users to share digital objects through the network. For security reasons, users can communicate with each other relying on a public key infrastructure wherein a certificate authority (CA) is involved. The CA is also referred to as a trusted third party (TTP), which is an entity to facilitate interactions between users who trust this third party. The CA issues digital certificates for users to secure the communication between users.

In the sharing of a digital object, users who wish to share their digital object may define one or more access permissions to the digital object. The one or more access permissions may be transmitted to the trusted third party, which manages all the access permission information from all the owners of the digital objects in the system, and transmits the access permission information to all the consumers. Alternatively, the producer can directly send the access permission to the consumer. It is desirable that access permission issued can be amended, for example, be revoked.

It is desirable to have a flexible mechanism such that access permission to digital objects may be flexibly controlled. It is also desirable to have a less costly mechanism for the updating of the access permission to digital objects within the system.

### SUMMARY OF THE INVENTION

In an embodiment of the invention, a digital object owner client computing device is provided. The device may include a digital object storage to store at least one digital object the digital object owner client computer owns, an access permission creation circuit to create or amend access permission message to the at least one digital object for one or more uniquely addressed digital object consumer client computing device, and a transmitter to transmit the created or amended access permission message.

In an embodiment of the invention, a digital object access permission server computing device is provided. The digital object access permission server computing device may include a receiver to receive a created or amended access permission message from a digital object owner client computing device; an access permission storage to store at least one personalized access, permission message for a digital object, wherein the at least one personalized access permission message is uniquely addressed to one of at least one digital object consumer client computing device; and a transmitter to transmit the at least one personalized access permission message to the digital object consumer client computing device uniquely addressed in the at least one personalized access permission message.

In an embodiment of the invention, a trusted server computing device is provided, which may include a receiver to receive a created or amended access permission message generated by at least one digital object owner client computing device, and an access permission creation circuit to generate at least one personalized access permission message for at least one digital object from the received created or amended access permission message. Each of the at least one access permission message is uniquely addressed to one of at least one digital object consumer client computing device. The trusted server computing device may include a transmitter to transmit the at least one personalized access permission message.

In an embodiment of the invention, a digital object consumer client computing device is provided. The device may include a digital object storage to store at least one digital object and an application circuit to carry out an application using the at least one digital object. The device may further include an enforcer circuit to enforce a download of at least one personalized access permission message being assigned to the at least one digital object, wherein the at least one personalized access permission message is uniquely addressed to the digital object consumer client computing device. An access permission determination circuit may be included to determine the downloaded at least one personalized access permission message, and an access control circuit may, be included to control the access of the application to the at least one digital object depending on the downloaded at least one personalized access permission message.

In an embodiment of the invention, a system for generating and distributing access permission to at least one digital object is provided. The system may comprise a digital object owner client computing device, a trusted server computing device, and a digital object consumer client computing device, in accordance with the embodiments of the invention as described above.

In an embodiment of the invention, a system for generating and distributing access permission to at least one digital object is provided. The system may comprise a digital object owner client computing device, a digital object access permission server computing device, a trusted server computing device, and a digital object consumer client computing device in accordance with the embodiments of the invention as described above.

In an embodiment of the invention, a method of generating a created or amended access permission message by a digital object owner client computing device, a method of distributing access permission message for at least one digital object by a digital object access permission server computing device, a method of generating a personalized access permission message by a trusted server computing device, a method of controlling access to at least one digital object by a digital object consumer client computing device, and a method of generating and distributing access permission to at least one digital object by a system are provided.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1A and 1B show a digital object owner client computing device and a digital object consumer client computing device in accordance with an embodiment of the invention, respectively.

FIGS. 2A and 2B show a digital object access permission server computing device and a trusted server computing device according to an embodiment of the invention, respectively.

FIGS. 3A to 3E show flowcharts of sharing at least one digital object subject to access permission generated by the producer according to an embodiment of the invention.

FIG. 4 shows a system for generating and distributing access permission information for digital objects according to an embodiment of the invention.

FIG. 5 shows a flowchart of generating a created or amended access permission message by a digital object owner client computing device in one embodiment of the invention.

FIG. 6 shows a flowchart of distributing access permission message for at least one digital object by a digital object access permission server computing device in an embodiment of the invention.

FIGS. 7A and 7B show a flowchart of storing and generating a personalized access permission message by a trusted server computing device according to an embodiment of the invention.

FIG. 8 shows a flowchart of controlling access to at least one digital object by a digital object consumer client computing device according to an embodiment of the invention.

FIG. 9A shows a structure of an access permission message in accordance with an embodiment of the invention.

FIG. 9B shows a flowchart of periodically downloading the access permission message of FIG. 9A according to an embodiment of the invention.

FIG. 10A shows a structure of an updated access permission message in accordance with an embodiment of the invention.

FIG. 10B shows a flowchart of periodically obtaining the updated access permission message of FIG. 10A according to an embodiment of the invention.

FIGS. 11A and 11B show a structure of a complete access permission message and a structure of an augmented access permission message in accordance with an embodiment of the invention, respectively.

FIG. 11C shows a flowchart of periodically obtaining the updated access permission message according to another embodiment of the invention.

FIG. 12 shows a Merkle hash tree in accordance with an embodiment of the invention.

### DESCRIPTION

In this context, the computing device as referred to includes but is not limited to any computing processor, computer, mobile phone, personal digital assistant (PDA), notebook, laptop, personal computer, workstation, etc.

One embodiment of the invention relates to a digital object owner client computing device. The device may include a digital object storage to store at least one digital object the digital object owner client computing device owns, a key storage to store a public key of a trusted server computing device and/or a private key of the digital object owner client computing device (the key storage is optional in an alternative embodiment of the invention), and an access permission creation circuit to create or amend access permission message to the at least one digital object for a uniquely addressed digital object consumer client computing device. The device may further include a cryptographic circuit to provide at least one public key cryptographic algorithm, wherein the cryptographic circuit may be configured to encrypt the created or amended access permission message using the public key of the trusted server computing device and/or digitally sign the created or amended access permission message using the private key of the digital object owner client computing device; and a transmitter to transmit the created or amended access permission message. In an embodiment of the invention, also the cryptographic circuit is optional.

In this embodiment, the digital object owner client computing device, also exchangeably referred to as “producer”, owns at least one digital object which may be shared with other users. The producer creates/amends access permission message to the at least one digital object for the uniquely addressed user, and the access to the shared digital object by the user is permitted subject to the created or amended access permission message. In an embodiment of the invention, the digital object may include at least a portion of a file, e.g., a text document, an image file, an audio file, a video file or a multimedia file. In another embodiment, the digital object may include at least a portion of a computer program.

In one embodiment, the key storage may store a symmetric key as used in a symmetric key based key management scheme, e.g. Kerberos. In another embodiment, the the cryptographic circuit may be configured to encrypt the created or amended access permission message using the symmetric key. For encryption, any kind of symmetric encryption algorithm may be provided such as e.g. the Data Encryption Standard (DES), the Triple DES, the Advanced Encryption Standard (AES), Blowfish, International Data Encryption Algorithm (IDEA), Twofish, CAST-128, CAST-256, RC2, RC4, RCS, RC6, etc.

The producer may include a further key storage to store a public key of a digital object consumer client computing device (also exchangeably referred to as “consumer”). This public key might have been obtained from a public directory of public keys. The cryptographic circuit of the producer may be configured to encrypt the digital object using the public key of the consumer, such that only the consumer who has the corresponding private key may decrypt the encrypted digital object.

In one embodiment, the created or amended access permission message may be encoded using the XML format. In one example, the created or amended access permission message are encoded in a data structure similar to a X.509 Certificate Revocation List format. The created or amended access permission message may refer to an access permission message with newly defined access permission, or may refer to an access permission message with amended access permission. In another embodiment, the created or amended access permission message is encoded similar to the incremental Certificate Revocation List format as will be explained in more detail below. It should be noted that any other encoding scheme or data structure may be provided instead of using the X.509 standard.

In an embodiment, the created or amended access permission message includes at least one of the following data items: identity of the digital object owner client computing device; time of the created or amended access permission message; identity of at least one digital object consumer client computing device; identity of the at least one digital object; type, time and duration of new access permission associated with the at least one digital object and the at least one digital object consumer client computing device; type and time of amended access permission associated with the at least one digital object and the at least one digital object consumer client computing device; expiry date of the previous created or amended access permission, digital signature of the digital object owner client computing device.

The access permission may include but may not be limited to any of the following permissions: output, execute, edit, delete, copy or download for a predetermined number of times or within a predetermined period. The permission to output includes any kinds of ouput, e.g. view, read, open, print or play, where appropriate, a multimedia file, a video, an audio, an image file or a text document, etc.

In one embodiment, the cryptographic circuit is configured to provide at least one of the following encryption algorithms: RSA; an encryption algorithm using elliptic curves; Paillier cryptosystem encryption; ElGamal encryption; or Cramer-Shoup cryptosystem. Other encryption algorithms for a public key infrastructure may also be used in alternative embodiments of the invention.

The created or amended access permission message may be transmitted to a digital object access permission server computing device which may be a non-trusted server to distribute the access permission message between the producer and the trusted server. In another embodiment, the created or amended access permission message may also be transmitted to a trusted server computing device which may consolidate the received created or amended access permission messages to generate personalized access permission message.

Another embodiment of the invention provides a digital object access permission server computing device. The device may include a receiver to receive a created or amended access permission message, and an access permission storage to store at least one personalized access permission message for a digital object. Each of the at least one personalized access permission message is uniquely addressed to one of at least one digital object consumer client computing device. The device may further include a transmitter to transmit the at least one personalized access permission message to the at least one digital object consumer client computing device.

In this context, the digital object access permission server computing device as defined above is also exchangeably referred to as “server”. The server may be a non-trusted server which serves to distribute access permission message between the producer, the trusted server and the consumer. The server may also be a trusted server which serves to distribute access permission message between the producer and the consumer.

In an embodiment, the created or amended access permission message may have been encrypted using a public key of a trusted server computing device and/or digitally signed using a private key of the digital object owner client computing device. In another embodiment, the created or amended access permission message may be encrypted using a symmetric key.

In an embodiment, the at least one personalized access permission message is digitally signed using a private key of the trusted server computing device. In another embodiment, the at least one personalized access permission message is encrypted using a symmetric key.

In one embodiment, the transmitter is further configured to transmit the created or amended access permission message to the trusted server computing device. Thus, the server distributes the created or amended access permission message from the producer to the trusted server.

In another embodiment, the receiver may also be configured to receive the at least one personalized access permission message from the trusted server computing device. Thus, the server distributes the personalized access permission message from the trusted server computing device to the at least one digital object consumer client computing device.

Similarly, the digital object may include at least a portion of a file or at least a portion of a computer program as explained above.

In one embodiment, the personalized access permission message may be encoded using the XML format. In one example, the protected access permission message may be encoded in a format similar to the X.509 standard Certificate Revocation List format, or similar to the incremental Certificate Revocation List format as will be explained in more detail below.

A further embodiment of the invention provides a trusted server computing device. The trusted server computing device may include a receiver to receive at least one (optionally cryptographically protected) created or amended access permission message, and an access permission creation circuit to generate at least one personalized access permission message for at least one digital object from the. (optionally cryptographically protected) created or amended access permission message. Each of the at least one personalized access permission message is uniquely addressed to one of at least one digital object consumer client computing device. The trusted server computing device may also include a transmitter to transmit the at least one personalized access permission message.

In this context, the trusted server computing device is exchangeably referred to as the “trusted server”. The trusted server is a trusted third party. The trusted server therefore generates personalized access permission message for each consumer and may digitally sign the personalized access permission message for authentication purposes.

In one embodiment, the transmitter may transmit the at least one personalized access permission message to a server as explained above, which then transmits the at least one personalized access permission message to a consumer. In another embodiment, the transmitter may transmit the at least one personalized access permission message directly to a consumer.

Similarly, the digital object may include at least a portion of a file or at least a portion of a computer program as explained above.

In one embodiment, the created or amended access permission message may be encrypted using a public key of the trusted server and/or digitally signed using a private key of a digital object owner client computing device. In another embodiment, the created or amended access permission message may be encrypted using a symmetric key.

The created or amended access permission message may be uniquely addressed to at least one digital object consumer client computing device (i.e., consumer).

In an embodiment of the invention, the trusted server may further include a cryptographic circuit to provide at least one public key cryptographic algorithm, wherein the cryptographic circuit is configured to digitally sign the at least one personalized access permission message using the private key of the trusted server. In another embodiment, the trusted server may include a cryptographic circuit to provide at least one symmetric key cryptographic algorithm, wherein the cryptographic circuit is configured to encrypt the at least one personalized access permission message using a symmetric key. In an embodiment, the trusted server may include a cryptographic circuit carry out a digital signature algorithm and/or a cryptographic hash algorithm. Other suitable cryptographic algorithms may also be carried out by the cryptographic circuit

The at least one personalized access permission message is derived from the created or amended access permission message, e.g. by decrypting the encrypted created or amended access permission message (and/or by verifying e.g. a digital signature provided over the created or amended access permission message) and deriving the access permission to the digital object associated with the at least one consumer.

In one embodiment, the at least one personalized access permission message may comprise all created or amended access permission to the at least one digital object, i.e., the complete access permission information for the consumer. In another embodiment, the at least one personalized access permission message may comprise access permission which has been created or amended since the previous generated personalized access permission message, i.e., the updated access permission information for the consumer. In this case, the updated access permission message has a smaller size and helps to save bandwidth costs.

In one embodiment, the personalized access permission message may be encoded using the XML format. In one example the personalized access permission message may be encoded in a format similar to X.509 Certificate Revocation List format, or similar to the incremental Certificate Revocation List format as will be explained in more detail below.

A further embodiment of the invention provides a digital object consumer client computing device, exchangeably referred to as a consumer. The consumer includes a digital object storage to store at least one digital object and an application circuit to carry out an application using the at least one digital object. The consumer may further include an enforcer circuit to enforce a download of at least one personalized access permission message being assigned to the at least one digital object, wherein the at least one personalized access permission message is uniquely addressed to the digital object consumer client computing device. An access permission determination circuit may be included to determine the downloaded at least one personalized access permission message, and an access control circuit may be included to control the access of the application to the at least one digital object depending on the downloaded at least one personalized access permission message.

In one embodiment, the consumer may further include a cryptographic circuit to provide at least one public key cryptographic algorithm, wherein the cryptographic circuit may be configured to decrypt the encrypted at least one digital object, thereby forming the at least one digital object.

In another embodiment, the consumer may further include a key storage to store a public key of a trusted server computing device. The consumer may include a cryptographic circuit to provide at least one public key cryptographic algorithm, wherein the cryptographic circuit may be configured to authenticate the trusted server computing device using the public key of the trusted server computing device.

In one embodiment, the downloaded personalized access permission message may be encrypted by the trusted server. The cryptographic circuit of the consumer may be further configured to provide at least one of decryption algorithms, such as RSA, an decryption algorithm using elliptic curves, Paillier cryptosystem decryption and ElGamal decryption, so as to decrypt the downloaded personalized access permission message. Other corresponding decryption algorithms may also be used if the personalized access permission message is encrypted using other algorithms.

In another embodiment, the consumer may include a cryptographic circuit to provide at least one symmetric key cryptographic algorithm. The cryptographic circuit may be configured to decrypt the downloaded personalized access permission message using the symmetric key, which is also used for encrypting the downloaded personalized access permission message.

According to an embodiment, the enforcer circuit is configured to download the at least one personalized access permission message at a plurality of predetermined time instants. For example, if the at least one personalized access permission message is not downloaded after the expiry of a predetermined period of time, the access of the application to the digital object may be denied.

In one embodiment, the downloaded at least one personalized access permission message comprises a reference number being a function of the time at which the downloaded at least one personalized access permission message is generated. In another embodiment, the enforcer circuit may be configured to determine the reference numbers of at least one personalized access permission message to be downloaded based on the current time and the reference number of a previous downloaded personalized access permission message, and to enforce the download of the at least one personalized access permission message comprising the determined reference numbers.

Similarly, the digital object may include at least a portion of a file or at least a portion of a computer program as explained above.

In one embodiment, the downloaded personalized access permission message may be encoded, using the XML format. In one example, the downloaded personalized access permission message may be encoded in a format similar to X.509 Certificate Revocation List format, or similar to the incremental Certificate Revocation List format in another example as will be explained in more detail below.

In an embodiment, the at least one personalized access permission message includes at least one of the following data items:
version of the access permission message format,
identity of the trusted server computing device,
identity of a digital object consumer client computing device to which the access permission message is addressed,
the time the current access permission message is created or amended,
the time a next access information message will be created or amended,
a reference number of the current access permission message,
identity of the at least one digital object,
type, time and duration of new access permission associated with the at least one digital object and the digital object consumer client computing device,
type and time of revoked unexpired access permission associated with the at least one digital object and the digital object consumer client computing device,
type and time of revoked unexpired access permission associated with the at least one digital object and the digital object consumer client computing device since the previous access permission message,
expired access permission associated with the at least one digital object and the digital object consumer client computing device since the previous access permission message,
unexpired access permission associated with the at least one digital object and the digital object consumer client computing device since the previous access permission message,
digital signature of the trusted server computing device.

The at least one access permission as defined in the access permission message may include but are not limited to any of the following permissions: output, execute, edit, delete, copy or download for a predetermined number of times or within a predetermined period.

A futher embodiment of the invention relate to a system for generating and distributing access permission to at least one digital object. The system may comprise a digital object owner client computing device, a trusted server computing device, and a digital object consumer client computing device described above. The system will be described in detail below.

Another embodiment of the invention relates to a system for generating and distributing access permission to at least one digital object. The system may comprise a digital object owner client computing device, a digital object access permission server computing device, a trusted server computing device, and a digital object consumer client computing device as described above. The system will be described in detail below.

Other embodiments of the invention relate to a method of generating a created or amended access permission message by a digital object owner client computing device described above, a method of distributing access permission message for at least one digital object by a digital object access permission server computing device described above, a method of generating a personalized access permission message by a trusted server computing device described above, a method of controlling access to at least one digital object by a digital object consumer client computing device described above, and a method of generating and distributing access permission to at least one digital object by a system described above. These embodiments will be described in more detail below with regard to the figures.

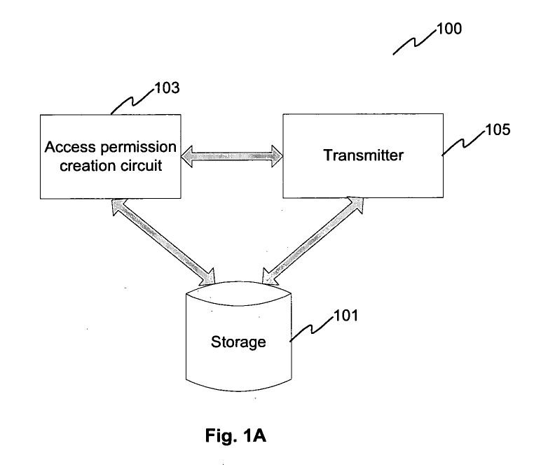

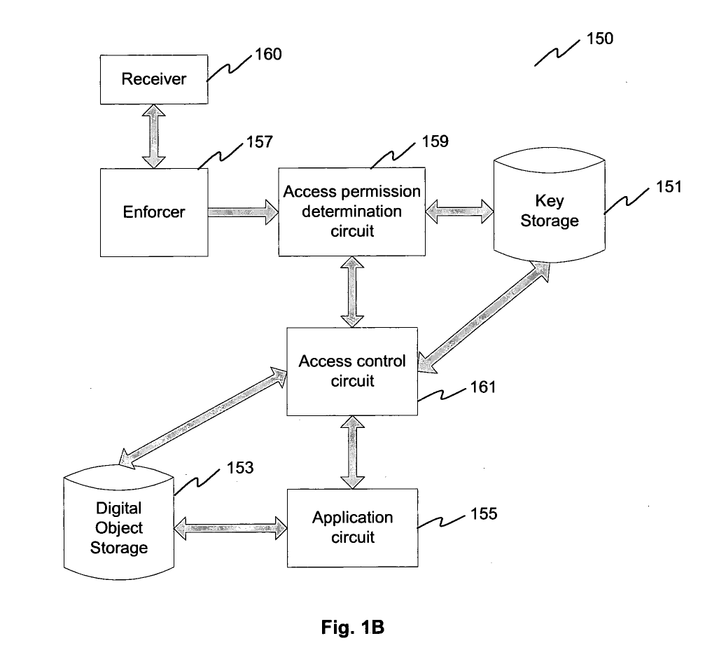

FIG. 1A shows a digital object owner client computing device (the producer) 100 in accordance with an embodiment of the invention.

The producer 100 may include a storage 101 to store at least one digital object. Relevant information of the digital object, for example, encryption keys associated with the digital object, and sent/received information pertaining to the digital object, may be stored in the storage 101. The storage 101 may also store keys, such as a public key of a trusted server, a public key of a consumer, a public/private key pair of the producer and a symmetric key used in a symmetric key cryptographic algorithm. In addition, access permission associated with the at least one digital object may be stored in the storage 101. It is understood that there may be more than one storage 101 in the producer 100, wherein some storage(s), which stores secret information, may be protected using password or tokens. The storage 101 may include volatile storage 101 and/or non-volatile storage 101.

The producer 100 may further include an access permission creation circuit 103 to creat or amend access permission message to the at least one digital object for one or more uniquely addressed consumer.

The producer 100 further includes a transmitter 105 to transmit the created or amended access permission message, e.g. to a server.

The producer 100 may optionally include a cryptographic circuit (not shown in FIG. 1) to provide at least one public key cryptographic algorithm, and to encrypt the created or amended access permission message using the public key of the trusted server computing device and/or digitally sign the created or amended access permission message using the private key of the producer. Examples of the public/private key cryptographic algorithm include but are not limited to RSA, an encryption algorithm using elliptic curves, Paillier cryptosystem encryption, and ElGamal encryption, etc. The cryptographic circuit may be configured to provide at least one symmetric key cryptographic algorithm and to encrypt the created or amended access permission message using a symmetric key, in another embodiment. Examples of the symmetric key cryptographic algorithm include DES, Triple DES, AES, Blowfish, IDEA, Twofish, CAST-128, CAST-256, RC2, RC4, RCS, RC6, etc.

FIG. 1B shows a digital object consumer client computing device (the consumer) 150 according to an embodiment of the invention.

The consumer 150 may include a digital object storage 153 to store at least one digital object. The consumer 150 may further include a key storage 151 to store keys and access permission message relating to the at least one digital object. An application circuit 155 may be included to carry out an application using the at least one digital object. The application circuit 155 may be a software program, for example, Microsoft Paint, to open a digital object which is a JPEG image document. The application circuit 155 may also be a hardware, for example, a screen for displaying the digital object.

The consumer 150 may further include an enforcer circuit 157 to enforce a download of at least one personalized access permission message being assigned to the at least one digital object, wherein the at least one personalized access permission message is uniquely addressed to the consumer. This would ensure that the access permission for the consumer is updated. The consumer 150 may include a receiver 160 to receive the at least one personalized access permission message in an embodiment.

An access permission determination circuit 159 is included to determine the downloaded personalized access permission message, for example, to determine the validity of the personalized access permission message and/or to determine the content of the personalized access permission message. In an embodiment, the access permission determination circuit 159 may be configured to authenticate the source of the personalized access permission message and/or to decrypt the personalized access permission message if encrypted.

Depending on the downloaded at least one personalized access permission message, an access control circuit 161 controls the access of the application to the at least one digital object. For example, from the downloaded personalized access permission message, if it is determined that the consumer's previous right to play a video is revoked, the video player of the consumer would not be able to play the video. This may be achieved by, for example, implementing the access control circuit 161 as a plug-in in the video player, or implementing the access control circuit 161 as a digital object user program associated with the video player.

It is understood that a computing device may act both as a producer and as a consumer, i.e., it can send/receive digital objects and associated permissions to/from other parties. Accordingly, a computing device in accordance with the invention may include both the producer 100 and the consumer 150 as described above.

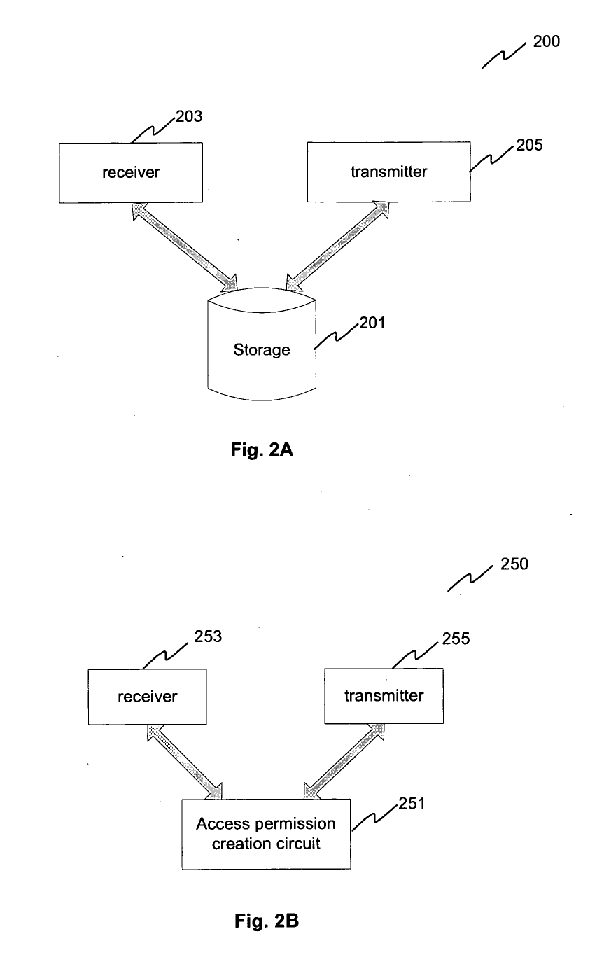

FIG. 2A shows a digital object access permission server computing device (the server) 200 according to an embodiment of the invention.

The server 200 may include a receiver 203 to receive a created or amended access permission message. The created or amended access permission message may be cryptographically protected (e.g. encrypted) using a public key of a trusted server computing device in an embodiment. In an alternative embodiment of the invention, the created or amended access permission message may be digitally signed by the producer 100 using the producer's 100 private key, thereby ensuring the authenticity of the producer 100. In a further embodiment, the created or amended access permission message may be encrypted using a symmetric key by the producer 100. An access permission storage 201 may be included to store at least one personalized access permission message for a digital object. The at least one personalized access permission message is uniquely addressed to one of at least one digital object consumer client computing device. In an embodiment, the at least one personalized access permission message may be digitally signed using a private key of the trusted server computing device. In another embodiment, the at least one personalized access permission message may be encrypted using a symmetric key. The access permission storage 201 may also store the received (optionally cryptographically protected) created or amended access permission message.

The server 200 may further include a transmitter 205 to transmit the at least one personalized access permission message to the at least one digital object consumer client computing device. The transmitter 205 may also be used to transmit the received (optionally cryptographically protected) created or amended access permission message to the trusted server.

FIG. 2B shows a trusted server computing device (the trusted server) 250.

The trusted server 250 may include a receiver 253 to receive an (optionally cryptographically protected) created or amended access permission message which may be optionally encrypted using a public key of the trusted server 250 and/or digitally signed using a private key of the producer 100. The created or amended access permission message may also be optionally encrypted using a symmetric key in another embodiment. An access permission creation circuit 251 is provided to generate at least one personalized access permission message for a digital object from the (optionally cryptographically protected) created or amended access permission message, wherein the personalized access permission message is uniquely addressed to one of at least one consumer 150.

The trusted server 250 may further include a transmitter 255 to transmit the at least one personalized access permission message, for example, to the consumer uniquely addressed in the personalized access permission message.

In an embodiment, the trusted server 250 may further include a cryptographic circuit (not shown in FIG. 2B) to provide at least one public key cryptographic algorithm or symmetric key cryptographic algorithm, so as to protect the at least one personalized access permission message using its private key or using a symmetric key.

The trusted server 250 may include one or more storage (not shown in FIG. 2B) for storing the received access permission message and the personalized access permission message as well.

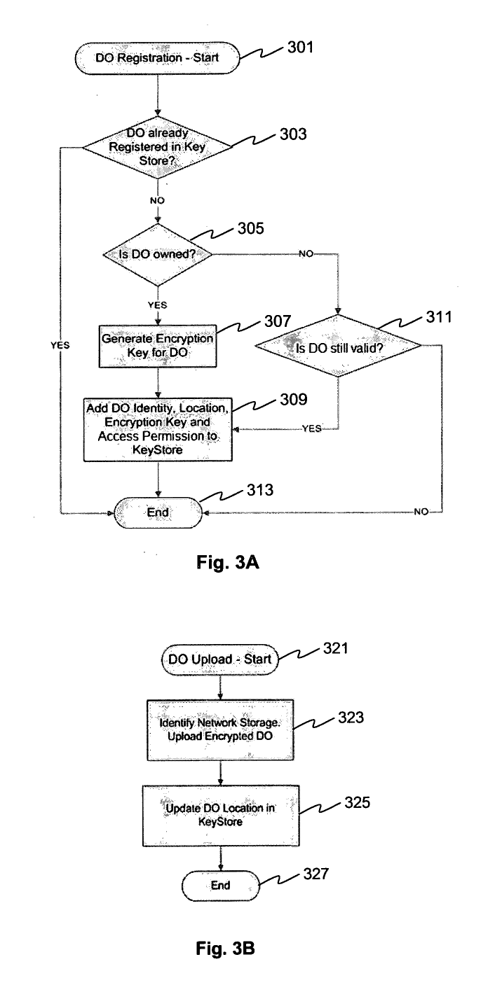

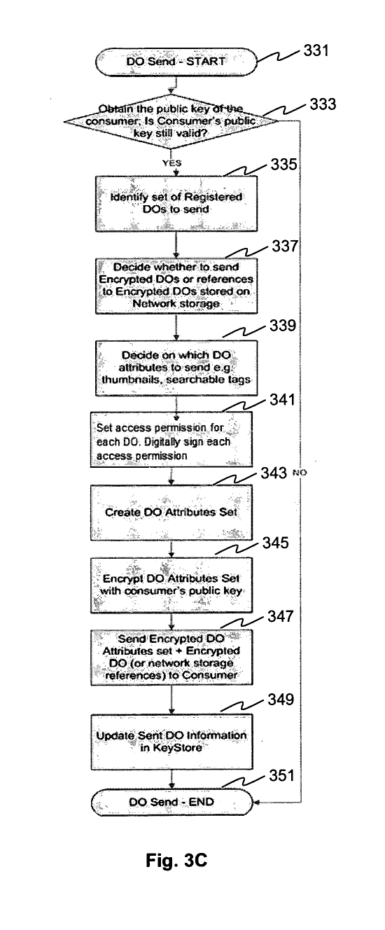

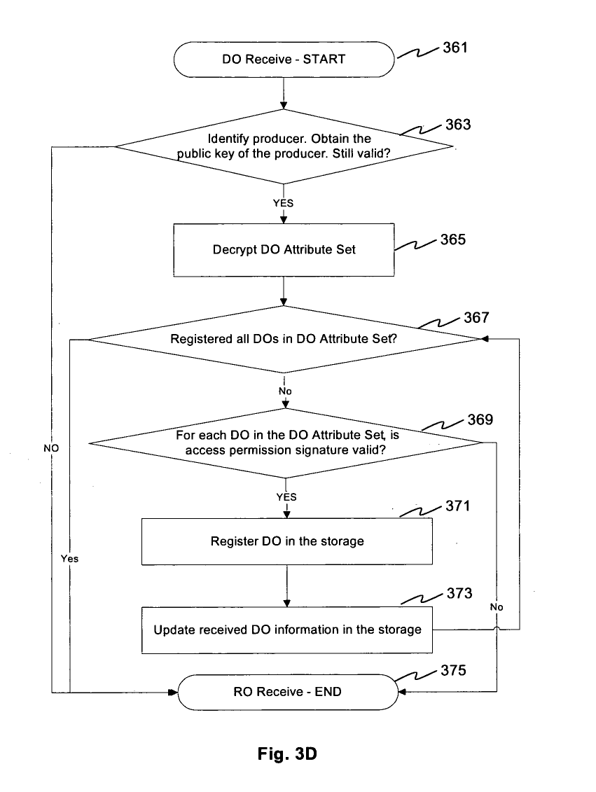

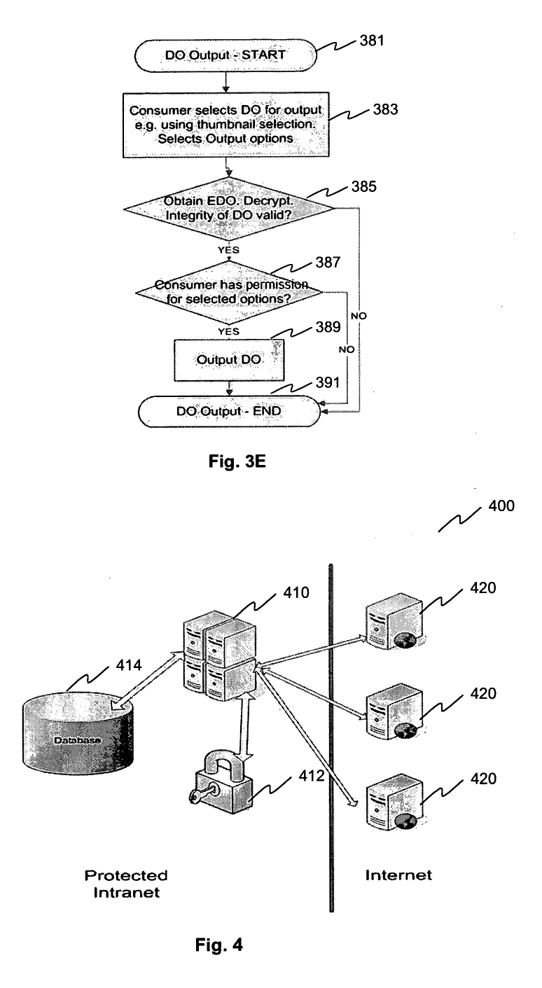

FIGS. 3A to 3E shows flowcharts of sharing at least one digital object subject to access permission generated by the producer according to an embodiment of the invention.

FIG. 3A shows an example of a registration of the digital object (DO) by the producer or the consumer in an embodiment. Before the producer sends a DO or after the consumer receives a DO, DO registration in a storage of the producer or the consumer, e.g. a key storage, starts at 301. At 303, it is determined whether the DO to be sent or received is already registered in the storage. If yes, the registration process ends at 313. If no, it is determined at 305 whether the DO is owned. If it is the producer to register the DO to be sent, the DO is owned by the producer, and encryption key for the DO will be generated at 307. If it is the consumer to register the DO received, the DO is not owned by the consumer, and the consumer will determine at 311 whether the DO is still valid, meaning whether the consumer has access permission to the DO. When the producer owns the DO or the consumer has access permission to the DO, the relevant information of the DO, such as the identity, location, encryption key and access permission of the DO, is added to the storage at 309. If the consumer has no access permission to the DO, the registration process ends at 313.

FIG. 3B shows DO upload by the producer in an embodiment. The DO upload starts at 321. A network storage, e.g. a server, is identified and the encrypted DO is uploaded to the network storage at 323. The location of the DO as stored in the storage of the producer is then updated at 325, and the uploading process ends at 327.

The transmitting of one or more digital objects in one embodiment is illustrated in FIG. 3C. The producer starts to transmit the DOs at 331. The producer obtains the public key of the consumer and determines if the consumer's public key is still valid at 333. If the consumer's public key is valid, e.g. by checking with a certificate authority, the producer proceeds to identify a set of registered DOs that are to be sent to the consumer at 335. The producer at 337 determines whether to send the identified encrypted DOs or to send references to the identified encrypted DOs uploaded to a network storage to the consumer. It is then determined at 339 which DO attributes are to be sent, e.g. thumbnails or searchable tags. The producer sets access permission for each DO and digitally signs each access permission at 341. At 343, a DO attributes set is created which may include the information determined above, such as the DO attributes to be sent and the access permission. The DO attributes set is encrypted using the consumer's public key at 345, and the encrypted DO attributes set together with the encrypted DOs or the network storage references to the encrypted DOs are sent to the consumer at 347. The DO information as sent to the consumer is updated in the storage at 349, and the transmitting process ends at 351.

FIG. 3D shows the flowchart of a consumer receiving and checking the DOs according to an embodiment. The receiving process starts at 361. At 363, the consumer identifies the producer of the received DOs, obtains the producer's public key, and checks, e.g. with a certificate authority, whether the producer's public key is still valid. If the producer's public key is still valid, the consumer proceeds to decrypt the received DO attribute set at 365, e.g. using the private key of the consumer. At 367, the consumer checks whether all the DOs in the DO attribute set have been registered in its storage. If not, the consumer determines for each DO in the DO attribute set whether the access permission's signature is valid at 369, e.g, using the producer's public key. If the signature is valid, the consumer registers the DOs in its storage, e.g. a key storage, at 371. The received DO information is updated accordingly in the storage at 373, and the receiving and checking process ends at 375.

FIG. 3E shows a flowchart of output the received DO by the consumer according to an embodiment of the invention. The consumer starts the DO output process at 381. At 383, the consumer selects the DO(s) for output, e.g. by using thumbnail selection, and selects the options for output, e.g. to print, play or display, etc. At 385, the encrypted digital object (EDO) is obtained and decrypted, and the validity of the integrity of the DO is checked. The consumer then determines at 387 whether he has permission for the selected options for output, by checking the access permission associated with the decrypted DOs in the storage. If yes, the DO can be output at 389 with the selected options, and the ouput process ends at 391.

The above process of sending and receiving DOs with corresponding access permissions may be carried out between the producer and the consumer, thereby achieving a peer-to-peer digital object sharing and access permission control. The producer may use a network storage for sharing the DOs with the consumer, or may sharing the DOs with the consumer directly. The access permission is associated with the shared DOs, and is created before the sending of the DOs from the producer.

FIG. 4 shows a system 400 according to an embodiment of the invention, wherein the access permission information for DOs are generated and distributed for producers and consumers. There is provided a trusted server 410 within a protected intranet. The trusted server 410 may include or be connected with a database 414, which for example stores the access permission information related to a plurality of digital objects owned by a plurality of producers. The trusted server 410 further has a signing/private key 412, which is used to sign the information sent from the trusted server such that the receiver may authenticate the signed information. The trusted server 410 is capable of generating personalised access permission message for each consumer based on the access permission information stored in the database 414 in one embodiment of the invention.

Distrubution servers 420 are provided in the Internet, which are connected with the trusted server 410. The distrubution servers 420 may connect with a plurality of producers and consumers through the internet, so as to distribute information between the trusted server 410 and the producers/consumers. The trusted server 410, the distribution servers 410 and the producers/consumers thus constitute a sytem for generating and distributing access permission to digital objects, so that digital objects can be shared under flexible control of the producer. By involving distribution servers 420, which do not need to be trusted servers, the cost of the system can be decreased.

The trusted server 410 and the distribution servers 420 will be explained in detail below with regard to the generation or distribution of access permission messages for digital objects.

After the producer transmits the DO and the associated access permission to the consumer, the producer may amend the granted access permission or create new access permission either on its own initiative or on demand from one or more consumers. For example, the consumer may have an enforcer requesting for a download of the access permission message periodically.

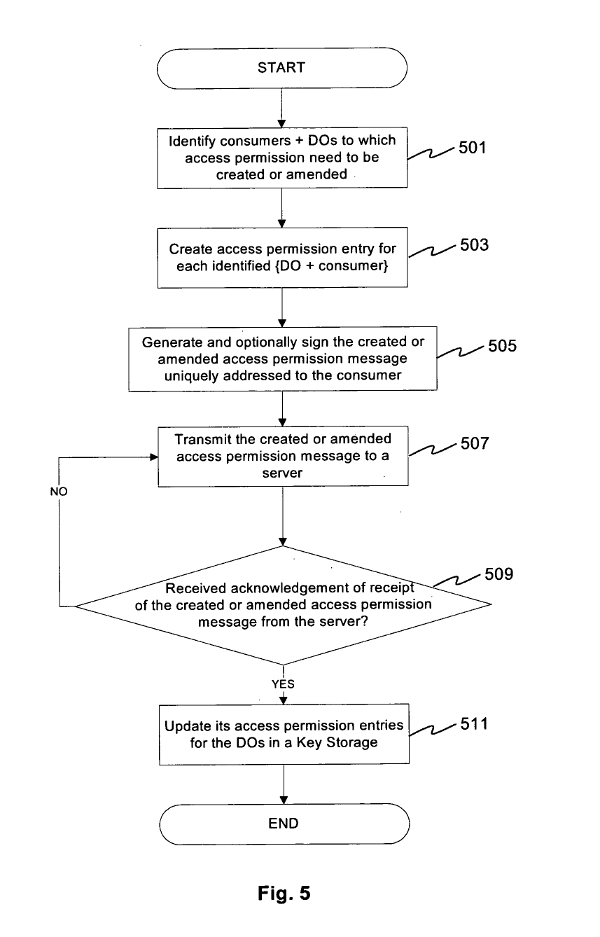

FIG. 5 shows a flowchart of generating a created or amended access permission message by a producer in one embodiment of the invention. At 501, the producer identifies the consumer(s) and the digital object(s) to which the access permission needs to be created or amended.

At 503, the producer creats access permission entries for each {DO and consumer} which is identied at 501. For example, the producer may decide to amend the previous access permission which allows a consumer to have full control over a text document to an amended access permission which only allows this consumer to view the text document. In another example, the producer may revoke the previous access permission granted to a consumer.

A created or amended access permission message which is uniquely addressed to one or more consumer is then generated and optionally signed (e.g. using the producer's private key) by the producer at 505. In this context, the created or amended access permission message is also called “a user privilege revocation list (UPRL)”. The created or amended access permission message can include not only revoked access permission entries, but also new access permission entries and amended access permission entries. For brevity, the created or amended access permission message as generated by the producer is referred to as UPRL in the following, and the format and the content of the UPRL will be explained in more detail below. The URPL may optionally be encrypted using a public key of a trusted server for security reasons.

The UPRL may include at least one of the following data items: identity of the producer; time of the created or amended access permission message; identity of the consumer(s); identity of the digital object(s); type, time and duration of new access permission associated with each {DO and consumer}; type and time of amended access permission associated with each {DO and consumer}, expiry date of the previous created or amended access permission, digital signature of the producer. The UPRL generated by the producer enables access permission to be created or amended on a per-consumer and per-DO basis.

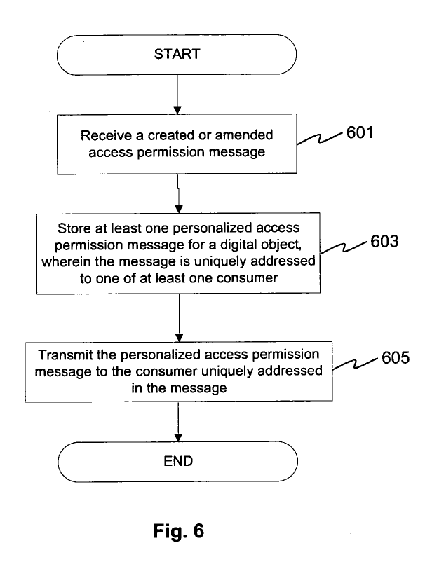

At 507, the producer transmits the UPRL, e.g. to a server. The producer determines at 509 whether an acknowledgement of receipt of the UPRL is received by the producer. If not, the producer will transmit the UPRL again as in 507. If it is acknowledged that such a message is received by the server, the producer updates its access permission entries for the DOs in the storage at 511. The server then transmits this UPRL to the trusted server as illustrated below in FIG. 6.

FIG. 6 shows a flowchart of distributing access permission message for at least one digital object by a digital object access permission server computing device in an embodiment of the invention. At 601, the server receives a created or amended access permission message (UPRL). The UPRL may be encrypted using a public key of a trusted server so that only the trusted server could access the UPRL. The UPRL may also be digitally signed using a private key of a producer so that the authentication of the UPRL is ensured. The UPRL may be sent from a producer, and the server upon receiving the UPRL may send an acknowledgement to the producer.

At 603, the server stores at least one personalized access permission message for a digital object. The at least one personalized access permission message is uniquely addressed to one of at least one consumer. In an embodiment, the at least one personalized access permission message may be cryptographically protected using a private key of the trusted server or a symmetric key. As the personalized access permission message is addressed specifically to the at least one consumer, it is also referred to as the protected personalized privilege revocation list (PPRL) in the following. The protected PPRL may be generated by the trusted server as will be explained below. The protected PPRL may optionally be encrypted using a public key of the at least one consumer, such that only the consumer to which the protected PPRL is uniquely addressed is able to decrypt the encrypted PPRL.

At 605, the server transmits the protected PPRL to the consumer uniquely addressed in the protected PPRL. The consumer may then authenticate or decrypt the protected PPRL and determine its access permission to the digital object. The server as described in this embodiment may be, for example, a distribution server 420 of FIG. 4.

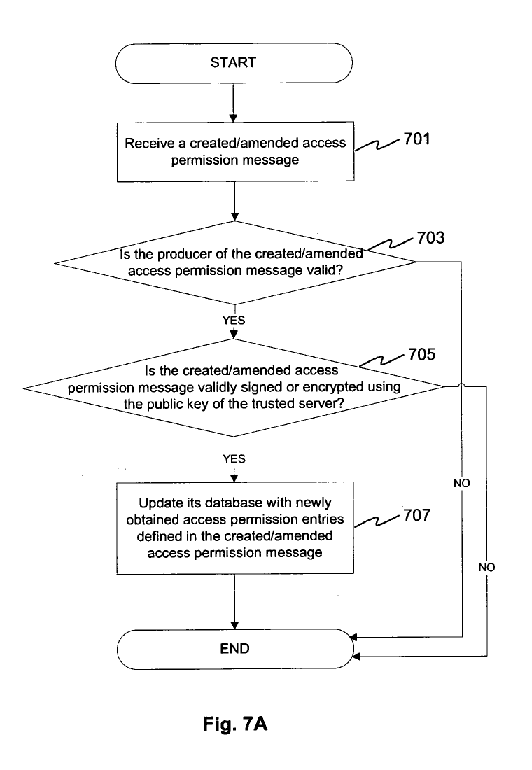

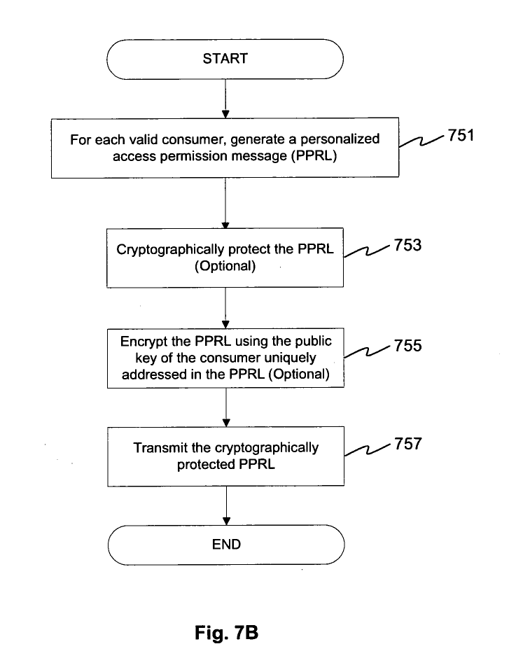

FIGS. 7A and 7B show a flowchart of generating a personalized access permission message by a trusted server computing device according to an embodiment of the invention.

The trusted server, for example, the trusted server 410 of FIG. 4, usually maintains a database, e.g., the database 414 of FIG. 4. The database includes all access permission information for all valid users, such as the producers and the consumers, of the trusted server. The trusted server may regularly update its database and purge expired access permission entries.

FIG. 7A shows the database update process according to an embodiment of the invention. The trusted server receives a cryptographically protected UPRL at 701, for example from a distribution server. The trusted server then determines whether the producer who generates the UPRL is a valid user of the trusted server at 703. If the producer is valid, the trusted server then determines whether the digital signature of the UPRL is valid if the UPRL is cryptographically protected using a digital signature of the producer in an embodiment. If the digial signature is valid, the trusted server updates its database at 707 with newly obtained access permission entries defined in the UPRL.

In another embodiment, the UPRL may be cyptographically protected by being encrypted using a public key of the trusted server. Then, instead of authenticating the validity of the digital signature at 705 above, the trusted server may use its private key to decrypt the encrypted UPRL at 705. In a further embodiment, the UPRL may both be digitally signed using a private key of the producer and be encrypted using the public key of the trusted server. In that case, the trusted server will both determine the validity of the digital signature and decrypt the encrypted UPRL at 705. In a further embodiment, the UPRL may be encrypted using a symmetric key. The trusted server may then decrypt the encrypted UPRL using the same symmetric key at 705.

With an updated database as explained above, the trusted server may periodically generate a PPRL either on its own initiative or on demand from the consumer. One embodiment of generating the PPRL is illustrated in FIG. 7B. At 751, the trusted server generates a PPRL for each valid consumer. As explained above, the PPRL specifies the created or amended access permission and is uniquely addressed to specific consumer to whom the access permission to the digital object is created or amended. The format and the content of the PPRL will be explained in detail below. Each PPRL is optionally cryptographically protected at 753, for example, using a digital signature of the trusted server and/or using a cryptographic hash algorithm, or both. The PPRL may be cryptographically protected using other methods as well.

Optionally, the PPRL may be encrypted at 755 using a public key of the corresponding consumer, such that only the specified consumer may decrypt the PPRL. The PPRL may in another embodiment be encrypted at 755 using a symmetric key if a symmetric key based key management scheme is used. The cryptographically protected PPRL is transmitted at 757, for example, to a distribution server as explained above.

In other embodiments of the invention, the trusted server may also act as a distribution server, such that trusted server will also carry out the distribution of the access permission message as described in FIG. 6. Thus, the trusted server may transmit the cryptographically protected PPRL to the corresponding consumers at 757.

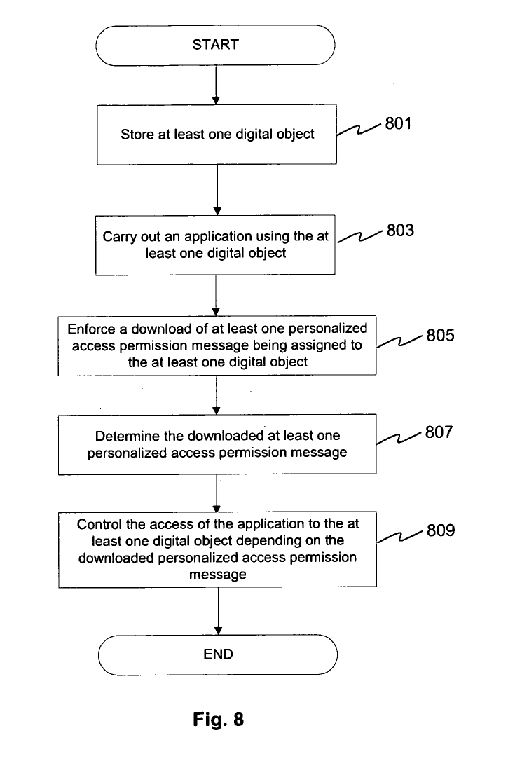

FIG. 8 shows a flowchart of controlling access to at least one digital object by a consumer according to an embodiment of the invention. At 801, the at least one digital object is stored, e.g. in a storage of the consumer. The consumer may carry out an application at 803 using the at least one digital object, e.g. to play a multimedia file using a multimedia player. At 805, an enforcer of the consumer enforces a download of at least one personalized access permission message being assigned to the at least one digital object. The personalized access permission message is uniquely addressed to the consumer, such as the PPRL as described above. The enforcer may enforce the download of the PPRL at a plurality of predetermined time instants.

At 807, the downloaded PPRL is determined, in one example, by checking the validity of the PPRL and in another example, by decrypting the PPRL if encrypted. Thereby, the producer created or amended access permission (e.g. the type and duration of the access permission) to the digital object as defined in the PPRL is determined. And the access of the application to the digital object is controlled depending on the downloaded PPRL at 809.

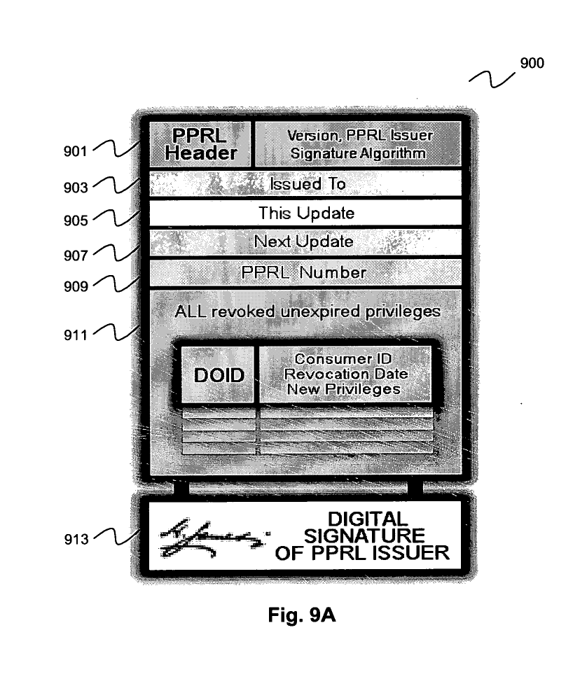

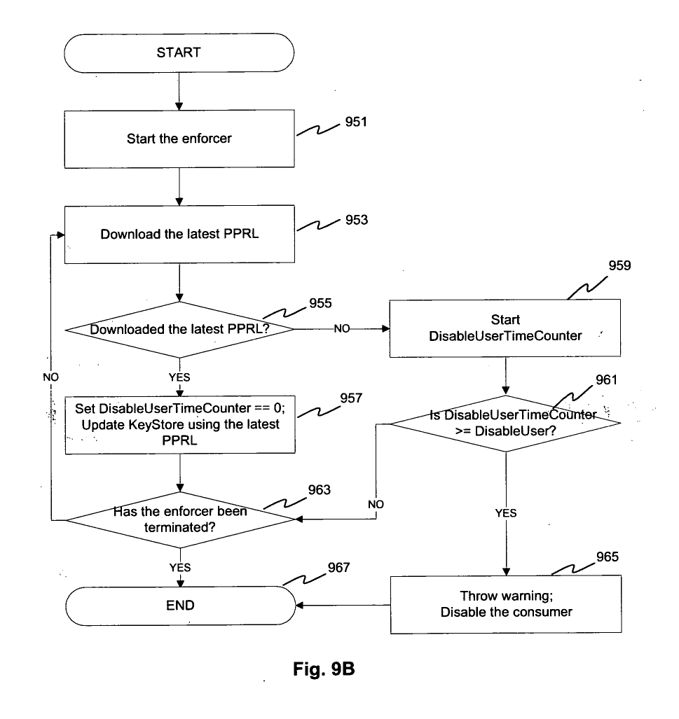

The structure of the PPRL 900 in accordance with an embodiment of the invention is shown in FIG. 9A.

The PPRL has a PPRL header 901, including the version of the PPRL format, the identity of the PPRL issuer (e.g. the trusted server) and optionally the signature algorithm for the issuer's signature. The “issued to” data item 903 includes identity of a consumer to which the PPRL is uniquely addressed. “This update” data item 905 and “Next update” data item 907 include the time the current access permission message is created or amended and the time a next access information message will be created or amended, respectively. PPRL number 909 is a reference number of the current PPRL, which may be a linear function of the time the PPRL is issued. The PPRL includes revoked unexpired privileges 911, which defines the time and type of revoked unexpired access permission associated with the respective digital object and the consumer. The PPRL may also include type, time and duration of new access permission associated with the respective digital object and the consumer, and/or expired access permission associated with the respective digital object and the consumer, which are not shown in FIG. 9A. The PPRL further includes a digital signature of the PPRL issuer 913 for the consumer to authenticate the PPRL issuer.

It is noticed that the PPRL structure 900 is similar to a CRL (certificate revocation list) format, which includes the CRL header (the version of the CRL format, the identity of the CRL issuer and the signature algorithm for the issuer's signature), “This update” data item, “Next update” data item, CRL number, revoked certificate information and digital signature of the CRL issuer. Thus, the access permission message generated by the trusted server, i.e. the PPRL, can be considered to be encoded similar to the CRL format. However, the PPRL structure according to the embodiment of the invention further includes “issued to” data item 903 which uniquely addresses a consumer. Furthermore, the revoked unexpired privileges 911 in the PPRL structure 900 includes revoked unexpired access permission associated with the respective digital object and the consumer. Therefore, the PPRL structure 900 provides a personalized access permission message.

It is understood that the UPRL generated by the producer may also be encoded similar to the CRL format as described above. The UPRL may include the data item uniquely addressing one or more consumers as the PPRL structure 900 as well.

FIG. 9B shows a flowchart of periodically downloading the PPRL, e.g. as described in FIG. 9A, by the consumer according to an embodiment of the invention.

The enforcer of the consumer is started at 951, and the latest PPRL is downloaded at 953. If it is determined that the lastest PPRL is downloaded at 955, a counter “DisableUserTimeCounter” of the enforcer is set to be “0” and the latest PPRL is updated in the storage of the consumer at 957. If it is determined that the latest PPRL is not downloaded at 955, the time counter “DisableUserTimeCounter” of the enforcer starts at 959. When the “DisableUserTimeCounter” is less than a predetermined time period “DisableUser” at 961, it is determined at 959 whether the enforcer has been terminated (if the enforcer is terminated, the consumer user program is also shut down). If not, the enforcer will download the latest PPRL as in 953. If yes, the downloading of the PPRL ends at 967. When the counter “DisableUserTimeCounter” is equal to or exceeding the predetermined time period “DisableUser” at 961, the enforcer will send a warning message and disable the consumer at 965. The downloading of the PPRL then ends at 967.

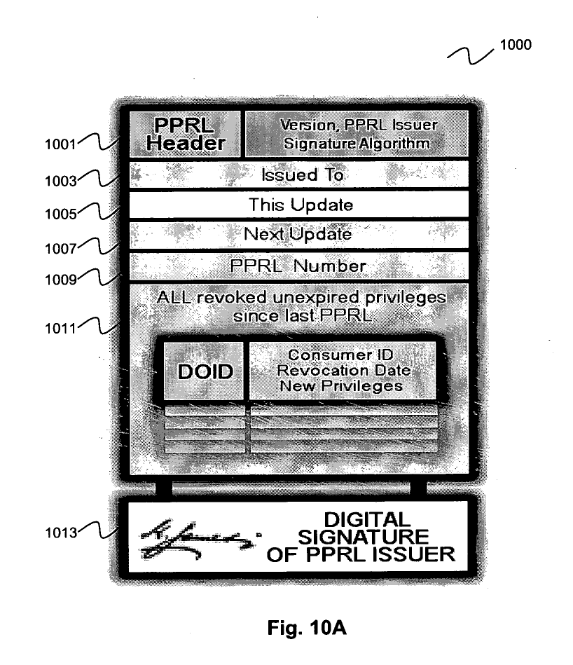

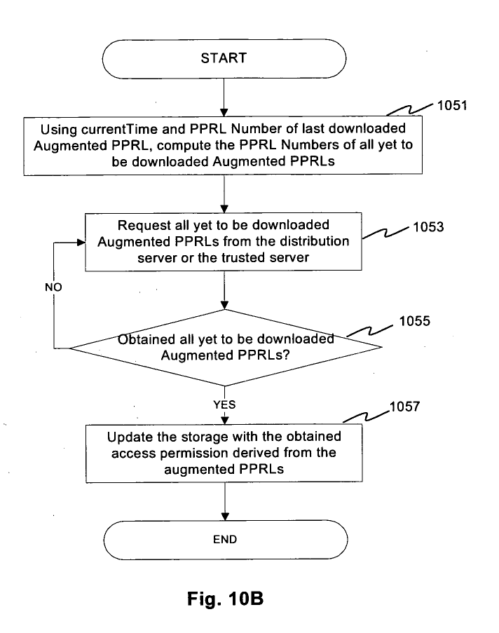

When the PPRL is large and the frequency of the downloding is high, bandwidth load may be increased. A structure of a PPRL according to another embodiment of the invention is shown in FIG. 10A, which helps to decrease the bandwidth load.

Similar to the structure of the PPRL 900 in FIG. 9A, the structure of the PPRL 1000, also referred to as “the augmented PPRL”, has a PPRL header 1001 including the version of the PPRL format, the identity of the PPRL issuer and optionally the signature algorithm for the issuer's signature. The “issued to” data item 1003 includes identity of a consumer to which the PPRL is addressed. “This update” data item 1005 and “Next update” data item 1007 include the time the current access permission message is created or amended and the time a next access information message will be created or amended, respectively. PPRL number 1009 is a reference number of the current PPRL, which may be a linear function of the time the augmented PPRL is issued.

Instead of all revoked unexpired privileges, the augmented PPRL 1000 may include all revoked unexpired privileges 1011 since the last PPRL, and defines the time and type of revoked unexpired access permission associated with the respective digital object and the consumer since the last PPRL. The augmented PPRL 1000 may also include expired access permission associated with the respective digital object and the consumer since the last PPRL, and/or unexpired access permission associated with the respective digital object and the consumer since the last PPRL, which are not shown in FIG. 10A. Thus, the augmented PPRL 1000, which includes only access permission information updated since the last PPRL, has a smaller sizer and may be used to decrease the bandwidth costs. The augmented PPRL 1000 further includes a digital signature of the PPRL issuer 1013 for the consumer to authenticate the PPRL issuer 1013.

It is noticed that the augmented PPRL structure 1000 is similar to an incremental CRL (certificate revocation list) format (as described e.g. in the patent application PCT/SG2005/000154), which includes the CRL header (the version of the CRL format, the identity of the CRL issuer and the signature algorithm for the issuer's signature), “This update” data item, “Next update” data item, CRL number, revoked certificate information since issuance of a base CRL, and digital signature of the CRL issuer over the content of the base CRL. The access permission message generated by the trusted server, i.e. the augmented PPRL, can be considered to be encoded in a format similar to the incremental CRL format. However, the augmented PPRL structure according to the embodiment of the invention further includes “issued to” data item 1003 which specifically refers to a consumer to which the augmented PPRL is uniquely addressed. Furthermore, the all revoked unexpired privileges 1011 in the augmented PPRL structure 1000 includes revoked unexpired access permission associated with the consumer. Therefore, the augmented PPRL structure 1000 provides a personalized access permission message.

It is understood that the UPRL generated by the producer may also be encoded according to the incremental CRL format as described above. The UPRL may include the data item uniquely addressing one or more consumers as the augmented PPRL structure 1000 as well.

FIG. 10B shows a flowchart of periodically obtaining the updated access permission information by the consumer according to an embodiment of the invention.

When the enforcer of the consumer starts to obtain the updated personalized access permission information, the enforcer computes the PPRL numbers of all the augmented PPRLs which are to be downloaded at 1051. The PPRL number of the augmented PPRL is a function of time as explained above, therefore the PPRL number of the augumented PPRL can be computed using the current time and the PPRL number of the last downloaded augmented PPRL. The enforcer of the consumer then requests all the augmented PPRLs which are to be downloaded from the distribution server or the trusted server at 1053, and the enforces downloads the requested augmented PPRLs until all the requested augmented PPRLs are obtained at 1055. The obtained access permission derived from the augmented PPRLs are updated in the storage of the consumer at 1057.

The enforcer may also include a counter as described in FIG. 9B so as to request the downloading of the updated access permission information at a plurality of predetermined time instants, and may disable the consumer's access to the digital object if the updated access permission information is not obtained.

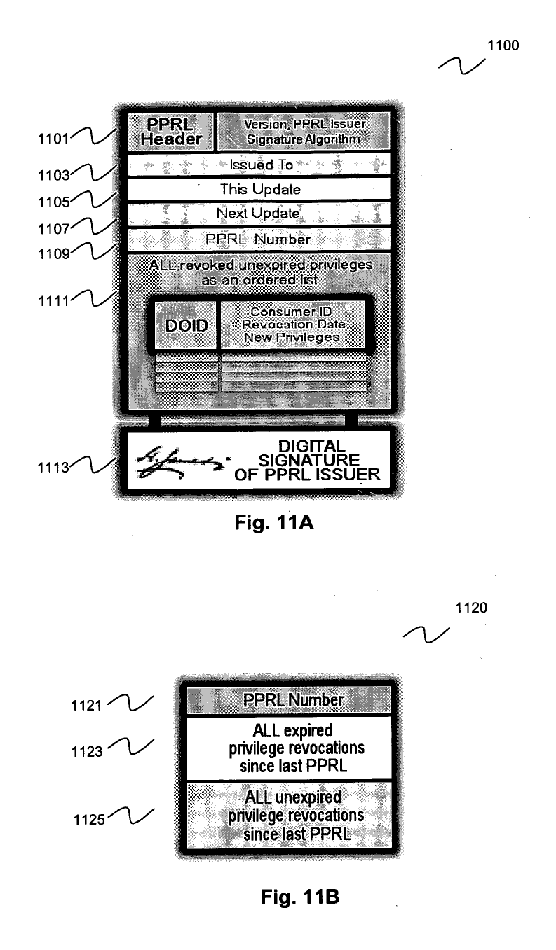

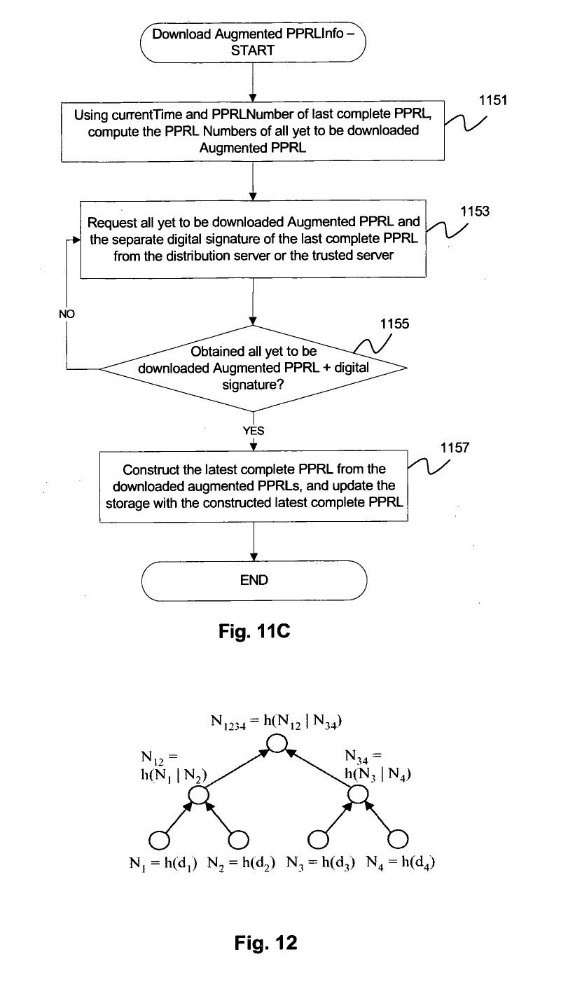

FIGS. 11A and 11B show a complete PPRL structure 1100 and an augumented PPRL structure 1120 according to another embodiment of the invention.

The complete PPRL 1100 is similar to the PPRL structure 900 of FIG. 9A. As shown in FIG. 11A, the PPRL has a PPRL header 1101, including the version of the PPRL format, the identity of the PPRL issuer and optionally the signature algorithm for the issuer's signature. The complete PPRL 1100 may also include the “issued to” data item 1103, “This update” data item 1105, “Next update” data item 1107, PPRL number 1109, all revoked unexpired privileges 1111, and a digital signature of the PPRL issuer 1113.

In an embodiment, the revoked unexpired privileges 1111 are ordered, e.g. in the ascending order of an index {DO and consumer}. The digital signature 1113 may be generated by the trusted server as a separate data structure.

FIG. 11B shows an augmented PPRL 1120, which includes a PPRL number 1121, all revoked expired privileges since the last complete PPRL 1123, and all revoked unexpired privileges since the last complete PPRL 1125.

The complete PPRL 1100, the separate digital signature of the complete PPRL, and the augmented PPRL 1120 are generated by the trusted server periodically. The data items of the complete PPRL 1100, including the PPRL hearder 1101 and “issued to” data item 1103, are made available to the consumer at the initialization of the system. “This update” data item 1105, “Next update” data item 1107 and PPRL number 1109 can be determined by the consumer if the update interval of the PPRL is made known to the consumer. In addition, digital signature of the complete PPRL is not included, since digital signature add additional data to the augmented PPRL 1120. For example, every RSA 1024 bit signature is 128 bytes. The digital signature is generated as a separate data structure as explained above.

Accordingly, the consumer may only need to download the augmented PPRL 1120 and the separate digital signature of the complete PPRL, based on which the consumer may derive the latest PPRL. In this case, the size of the augmented PPRL 1120 is decreased, without including digital signatures and the PPRL attributes as described above.

FIG. 11C shows a flowchart of periodically obtaining the updated access permission information by the consumer according to another embodiment of the invention.

When the enforcer of the consumer starts to obtain the updated access permission information, the enforcer computes the PPRL numbers of all the augmented PPRLs which are to be downloaded at 1151. The PPRL number of the augumented PPRL can be computed using the current time and the PPRL number of the last complete PPRL contructed by the consumer. The enforcer of the consumer then requests all the augmented PPRLs which are to be downloaded and the separate digital signature of the latest complete PPRL from the distribution server or the trusted server at 1153. The requested augmented PPRLs and the digital signature are downloaded at 1155. The consumer, e.g. the access permission determination circuit of the consumer, constructs the latest complete PPRL from the downloaded augmented PPRLs, and updates the contructed latest complete PPRL in the storage of the consumer at 1157.

Similarly, the enforcer may also include a counter as described in FIG. 9B so as to request the downloading of the updated access permission information at a plurality of predetermined time instants, and may disable the consumer's access to the digital object if the updated access permission information is not obtained.

In the above embodiments, the trusted server generates the PPRL for the respective consumer and signs the PPRL using its digital signature. Since each PPRL involves a digital signature operation, computing PPRLs for large number of consumers may be computationally expensive. In another embodiment of the embodiment, the PPRL generated by the trusted server may be authenticated using a cryptographic hash algorithm.

FIG. 12 illustrates a Merkle hash tree. In this example, data values d1, d2, d3 and d4 are to be authenticated. Each leaf node Ni is assigned a cryptographic hash h(di), where h is a one-way hash function e.g. SHA-1. The value of each internal node is derived from its child nodes, e.g. N12=h(N1═N2), where ═ denotes concatenation. The value of the root node is signed. The tree can be used to authenticate any subset of the data values, in conjunction with a verification object (VO). For example, to authenticate d1, the VO contains N2, N34 and the signed N1234. The recipient first computes h(d1) and h(h(h(d1)═N2)═N34), then checks if the latter is the same as the signed N1234. If so, d1 is accepted; otherwise, d1 has been tampered with.

To create signatures efficiently, in an embodiment of the invention, a hash tree may be used wherein the leaves of the tree constitute the cryptographic hash of the PPRL contents of every consumer. Every update interval, the trusted server re-computes this hash tree. The root of the hash tree is then digitally signed by the trusted server. Then, the signature over a PPRL is the signature of the hash root along with the VO of that particular consumer. For example, assuming that there are 4 valid consumers (U1, U2, U3, U4) in the system, N₁, N₂, N₃ and N₄ are the hashes of the PPRL contents of consumers U1, U2, U3 and U4. The digital signature bytes of the PPRL for U1 will be the digital signature over the root of the hash tree+the VO (N2, N34 and N1234).

In accordance with the above embodiments of the invention, the producer may create or amend access permission message which is uniquely addressed to a consumer, and transmit the created or amended access permission message either to a distribution server or to a trusted server. The trusted server may consolidate the received access permission messages created or amended by one or more producers in the system, and may generate personalized access permission message uniquely addressed to each consumer in the system. The personalized access permission message may be transmitted to the respective consumer either directly or through the distribution server. The consumer may then control the access to the respective digital object depending on the received personalized access permission message.

The trusted server may be configured to periodically generate the personalized access permission message either on its own initiative or on demand from the consumer (which may have a enforcer enforcing the download of the personalized access permission message periodically). The personalized access permission message may comprise all the created or amended access permission, or may only comprise the updated access permission since the previous personalized access permission message.

The above embodiments of the invention provides a flexible mechanism for the control of access permission to digital objects, wherein access permission can be created or amended on a per-consumer per-DO basis. Furthermore, the embodiments of the invention provides a cost efficient system for the control and distribution of access permission between producers and consumers.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A system for generating and distributing access permission to at least one digital object, comprising:
at least one digital object owner client computing device, wherein each of said at least one digital object owner client computing device is configured to transmit a created or amended access permission message to a trusted server computing device;
the trusted server computing device configured to generate at least one personalized access permission message from the created or amended access permission message, wherein each of the at least one personalized access permission message is uniquely addressed to one of at least one digital object consumer client computing device;
the at least one digital object consumer client computing device configured to enforce a download, from the trusted server computing device, of the at least one personalized access permission message uniquely addressed to the at least one digital object consumer client computing device.

2. The system of claim 1 further comprising a digital object access permission server computing device
wherein each of said at least one digital object owner client computing device is configured to transmit the created or amended access permission message to the digital object access permission server computing device and the digital object access permission server computing device is configured to transmit the created or amended access permission message to the trusted server computing device; and
wherein the trusted server is configured to transmit the at least one personalized access permission message to the digital object access permission server computing device and the at least one digital object consumer client computing device is configured to enforce a download, from the digital object access permission server computing device, of the at least one personalized access permission message uniquely addressed to the at least one digital object consumer client computing device.

3. The system of claim 1,
wherein the created or amended access permission message is encrypted using a public key of the trusted server computing device or using a symmetric key and/or digitally signed using a private key of the digital object owner client computing device.

4-5. (canceled)

6. The system of claim 1,
wherein the at least one digital object owner client computing device comprises an access permission creation circuit to generate the created or amended access permission message to the at least one digital object for a uniquely addressed digital object consumer client computing device.

7-8. (canceled)

9. The system of claim 1,
wherein the trusted server computing device is configured to generate the at least one personalized access permission message at a plurality of predetermined time instants.

10. The system of claim 9,
wherein the at least one personalized access permission message comprises all created or amended access permission to the at least one digital object, or comprises access permission which has been created or amended since the previous generated personalized access permission message.

11. (canceled)

12. The system of claim 1,
wherein the at least one digital object consumer client computing device comprises an enforcer circuit to enforce the download of the at least one personalized access permission message at a plurality of predetermined time instants.

13. The system of claim 1,
wherein the at least one digital object consumer client computing device comprises an access control circuit to control the access to the at least one digital object depending on the downloaded at least one personalized access permission message.

14. The system of claim 1,
wherein the at least one digital object consumer client computing device comprises a cryptographic circuit to provide at least one public key cryptographic algorithm, the cryptographic circuit being configured to authenticate the trusted server computing device using the public key of the trusted server computing device.

15-18. (canceled)

19. The system of claim 1,
wherein the created or amended access permission message include at least one of the following data items:
identity of the digital object owner client computing device;
time of the created or amended access permission message;
identity of at least one digital object consumer client computing device;
identity of the at least one digital object;
type, time and duration of new access permission associated with the at least one digital object and the at least one digital object consumer client computing device;
type and time of amended access permission associated with the at least one digital object and the at least one digital object consumer client computing device;
expiry date of the previous created or amended access permission,
digital signature of the digital object owner client computing device.

20-24. (canceled)

25. A trusted server computing device, comprising:
a receiver to receive at least one created or amended access permission message generated by at least one digital object owner client computing device;
an access permission creation circuit to generate at least one personalized access permission message for at least one digital object from the received created or amended access permission message,
wherein each of the at least one personalized access permission message is uniquely addressed to one of at least one digital object consumer client computing device;
a transmitter to transmit the at least one personalized access permission message.

26. (canceled)

27. The trusted server computing device of claim 25, further comprising
a cryptographic circuit to provide at least one public key cryptographic algorithm, wherein the cryptographic circuit is configured to protect the at least one personalized access permission message using its private key, or configured to encrypt the at least one personalized access permission message using a symmetric key.

28-36. (canceled)

37. A method of generating and distributing access permission to at least one digital object, the method comprising:
receiving, by a trusted server computing device, a created or amended access permission message from each of at least one digital object owner client computing device;
generating, by the trusted server computing device, at least one personalized access permission message from the created or amended access permission message, wherein each of the at least one personalized access permission message is uniquely addressed to one of at least one digital object consumer client computing device;
enforcing a download of the at least one personalized access permission message from the trusted server computing device to the digital object consumer client computing device uniquely addressed in the at least one personalized access permission message.

38. The method of claim 37, further comprising:
receiving, by a digital object access permission server computing device, the created or amended access permission message from each of the at least one digital object owner client computing device;
receiving, by the trusted server computing device, the created or amended access permission message from the digital object access permission server computing device;
transmitting the at least one personalized access permission message to the digital object access permission server computing device; and
enforcing a download of the at least one personalized access permission message from the digital object access permission server computing device to the digital object consumer client computing device uniquely addressed in the at least one personalized access permission message.

39. (canceled)

40. The method of claim 37, further comprising
generating the created or amended access permission message to the at least one digital object by the at least one digital object owner client computing device.

41. The method of claim 37, further comprising
encrypting the created or amended access permission message using a public key of the trusted server computing device or using a symmetric key and/or digitally signing the created or amended access permission message using a private key of the at least one digital object owner client computing device.

42-43. (canceled)

44. The method of claim 37, further comprising
generating the at least one personalized access permission message at a plurality of predetermined time instants.

45. The method of claim 44,
wherein the at least one personalized access permission message comprises all created or amended access permission to the at least one digital object, or comprises access permission which has been created or amended since the previous generated personalized access permission message.

46. (canceled)

47. The method of claim 37,
wherein the download of the at least one personalized access permission message is enforced at a plurality of predetermined time instants.

48. The method of claim 37, further comprising
controlling, by the at least one digital object consumer client computing device, the access to the at least one digital object depending on the downloaded at least one personalized access permission message.

49. The method of claim 37, further comprising
authenticating, by the at least one digital object consumer client computing device, the trusted server computing device using the public key of the trusted server computing device.

50-57. (canceled)

58. A method of generating a personalized access permission message by a trusted server computing device, the method comprising:
receiving at least one created or amended access permission message;
generating at least one personalized access permission message for at least one digital object from the received created or amended access permission message,
wherein each of the at least one personalized access permission message is uniquely addressed to one of at least one digital object consumer client computing device;
transmitting the at least one personalized access permission message.

59. (canceled)

60. The method of claim 58, further comprising
providing at least one public key cryptographic algorithm, thereby cryptographically protecting the at least one personalized access permission message using its private key.

61-67. (canceled)
